(19) United States
(12) Patent Application Publication
(10) Pub. No.: US 2026/0116022 A1
(43) Pub. Date: Apr. 30, 2026

(54) METHOD FOR MANUFACTURING A PART OF CYLINDRICAL SHAPE MADE FROM STIFFENED THERMOPLASTIC COMPOSITE MATERIAL

(71) Applicant: ARIANEGROUP SAS, LES MUREAUX (FR)

(72) Inventors: Frédérick CAVALIERE, LE HAILLAN (FR); Cécile LESAMBER, LE HAILLAN (FR); Alexis VILLEMAIN, LE HAILLAN (FR); Jean-Marc BARTOLUCCI, LE HAILLAN (FR)

(21) Appl. No.: 19/471,944

(22) PCT Filed: Apr. 1, 2024
(86) PCT No.: PCT/FR2024/050422

§ 371 Date: Oct. 2, 2025

(30) Foreign Application Priority Data
Apr. 3, 2023 (FR) FR2303250

(51) Int. Cl. B29C 70/34; B29C 70/30; B29C 70/44; B29L 31/00

(52) U.S. Cl. CPC B29C 70/342; B29C 70/304; B29C 70/446; B29L 2031/7154

(57) ABSTRACT

A method for manufacturing a stiffened cylindrical part, includes positioning a precursor assembly of the part to be manufactured in a tool, the assembly being made of thermoplastic preimpregnated fibrous material and including (i) a sectorized cylinder, and (ii) stiffening elements present on an internal surface of the cylinder, the tool including an internal part lined with a vacuum bag, facing the internal surface of the cylinder, on which the assembly is positioned, and an external molding part of cylindrical shape, facing an external surface of the cylinder, and the conformation of the assembly on the external molding part and the joining by co-consolidation of the stiffening elements on the internal surface of the cylinder with vacuum draw in the molding tool, in order to obtain the composite material part to which the stiffening elements are joined.

### TECHNICAL FIELD

The present disclosure concerns a method for manufacturing a part made of thermoplastic matrix composite material provided with stiffening elements welded by co-consolidation. The invention finds particular interest in the manufacture of cylindrical parts, called shells, intended to equip space launchers but is not limited to this application.

### PRIOR ART

Composite materials provide a savings in mass compared to metal materials, which is of particular interest in aerospace and aeronautical applications with a view to improving performance.

The known techniques for providing parts made of thermoplastic composite material having a cylindrical shape with stiffening elements do not give entirely satisfactory results. Such parts can in particular form interstage shells of space launchers, among other possible applications, which are generally subjected to high mechanical stresses and for which the use of stiffening elements is of particular importance.

Stiffeners made of thermoplastic composite material can be welded in processes where, at a minimum, the joining zone is heated so as to melt the resins present and then the assembly is set by cooling, However, in the particular case of parts and stiffening elements each having a cylindrical shape, the proper docking of these elements has very tight requirements regarding the shape tolerances of the parts that must be in contact, and these tolerances may be difficult to obtain in the case of double-curved shapes. The complexity of the method can be further increased if the production of a large part is desired. Known techniques can thus lead to play between the shell and the stiffening elements, due to a local weld defect, resulting in a notable reduction in the performance of the part, or even in production rejects.

In addition to this problem of managing air gaps, there is the problem of the design and the cost of the tools for carrying out this welding. The complex shapes used and the desire to position stiffening elements on an internal surface of the shell do not make this task easy, especially for maintaining the geometry of the parts despite the melting of the thermoplastics and for dismantling at the end of the process. US 2020298500 discloses a method and a system for the co-consolidation of parts made of thermoplastic composite material.

It is therefore desirable to have a method for manufacturing a shell made of stiffened composite material having a cylindrical shape that deals with all or some of the above-mentioned disadvantages.

### DISCLOSURE OF THE INVENTION

The present disclosure concerns a method for manufacturing a part of cylindrical shape made from stiffened thermo-plastic composite material, the method comprising:
positioning a precursor assembly of the part to be manufactured in a vacuum molding tool, the assembly being made of thermoplastic preimpregnated fibrous material and comprising (i) a sectorized cylinder formed by panels juxtaposed around an axis of the cylinder, and (ii) stiffening elements assembled on each of the panels and present on an internal surface of the cylinder,
   the tool comprising an internal part lined with a vacuum bag, facing the internal surface of the cylinder and stiffening elements, on which the assembly is positioned, and an external molding part of cylindrical shape, facing an external surface of the cylinder, and
the conformation of the assembly on the external molding part and the formation of the part by co-consolidation of the stiffening elements and the cylinder, comprising:
   heating the assembly during which a vacuum is drawn in the molding tool so that the vacuum bag applies pressure to press the stiffening elements against the internal surface of the cylinder and shape the assembly against the external molding part, and during which the thermoplastic resin(s) present in the assembly are melted or softened, and
   cooling the assembly, after said heating, during which the temperature is reduced to set the shape of the assembly thus produced and obtain the composite material part to which the stiffening elements are secured.

The positioning of the stiffening elements on each of the panels, which form cylinder sectors, is facilitated compared with an assembly on a complete shell. The shaping step implementing a pressing of the elements by vacuum draw coupled with a rise in temperature to fluidize these elements makes it possible to guarantee the proper docking of the stiffening elements on the cylinder and therefore the good mechanical strength of the welded connection, as well as a robust weld between adjacent panels. The composite material part is obtained by a so-called co-consolidation operation of the panels and stiffening elements which produces a weld, after cooling, due to the interpenetration of the polymer chains which took place during heating on either side of the welded interfaces.

In addition, the external positioning of the molding portion facilitates dismantling from an internal molding surface. The internal part in the invention has only a positioning function and not a molding function and therefore has a much simpler design and is more easily dismantled. In addition, the external molding part has a relatively simple design compared to an internal molding surface that must take into account the shape complexity generated by the stiffening elements and does not interfere with these elements that are located on the internal surface of the cylinder.

In one embodiment, the sectorized cylinder is formed by the panels juxtaposed around the axis of the cylinder with overlap between the adjacent panels.

Such a characteristic makes it possible to simplify the structure even further by allowing the panels to be welded directly together without requiring the use of a third mechanical interface element. However, it would not exceed the scope of the invention if the panels were juxtaposed edge-to-edge with the addition of a mechanical interface element, such as a splice bar, for the connection of each pair of adjacent panels.

In particular, adjacent panels may be thinner in their overlap zone in the direction of their edges.

Such a characteristic helps to further minimize misalignments and stress concentrations in the part obtained.

In one exemplary embodiment, each panel includes a plurality of circumferential frame sectors extending beyond the panel to form an extension, the extension being assembled with the frame sectors of an adjacent panel outside a junction zone between the two panels.

The assembly between the frame sectors introduces rigidity that is preferable to offset outside the junction zone in order to increase the flexibility of this zone and thus facilitate welding between the panels during co-consolidation. In addition, the assembly between the frame sectors helps to correctly position the panels to form the cylinder.

In an exemplary embodiment, the method further comprises, before positioning the precursor assembly in the molding tool, forming the panels by automatic fiber placement, the panels being draped on a form separate from the internal positioning part.

This technique makes it possible to have access to a wide variety of geometries, especially in relation to winding, or to drape local excess thicknesses or reinforcements in an automated way. In addition, the draping tool is separated from the vacuum molding tool, which reduces the manufacturing cycle time.

In one embodiment, the panels and stiffening elements comprise carbon fibers, glass fibers, aramid fibers, or a mixture of such fibers.

These fiber materials are particularly suitable for space launcher applications.

### BRIEF DESCRIPTION OF THE DRAWINGS

FIG. 1 schematically shows in perspective an example of a panel that can be used in the context of the invention.

FIG. 2 schematically and partially shows a cross-section, with respect to the X axis, of the panel in FIG. 1.

FIG. 2A schematically and partially shows the bevel angle of the panel in FIG. 2.

FIG. 3 schematically shows in perspective the overlapping of two adjacent panels according to an example of implementation of the invention.

FIG. 3A schematically and partially shows a detail of an example of an assembly between frame sectors of two adjacent panels.

FIG. 4 schematically and partially shows a variant of a sectorized cylinder.

FIG. 5 schematically and partially shows another variant of a sectorized cylinder.

FIG. 6 schematically and partially shows another variant of a sectorized cylinder.

FIG. 7 schematically and partially shows another variant of a sectorized cylinder.

FIG. 8 schematically and partially shows a precursor assembly of the part to be manufactured positioned in a vacuum molding tool in the context of an example of Implementation of the invention.

FIG. 9 schematically shows the heating under vacuum of the assembly shown in FIG. 8.

FIG. 10 schematically and partially shows the part obtained after cooling.

### DESCRIPTION OF THE EMBODIMENTS

The invention will now be described by means of figures, which are present for descriptive purposes to illustrate certain embodiments of the invention and which should not be interpreted as limiting it.

The sectorized cylinder is obtained by juxtaposition of thermoplastic preimpregnated fibrous panels. In general, it may comprise at least two fibrous panels, or even at least three fibrous panels. The example described here concerns the case of a four-panel cylinder.

The panels are advantageously made by automatic fiber placement, which constitutes a technique known per se. The panels 10 each comprise a fibrous reinforcement preimpregnated with a thermoplastic resin. The choice of reinforcing material and resin depends on the intended application. By way of example, the fibrous reinforcement comprises carbon fibers, glass fibers, aramid fibers, or a mixture of such fibers, By way of example, the resin is polyaryletherketone (PAEK), polyetheretherketone (PEEK), polyetherketoneketone (PEKK), polyethersulfone (PES), polyphenylene sulfide (PPS), or polyetherimide (PEI). Advantageously, the same resin is used in the different panels, or, failing that, compatible resins are used.

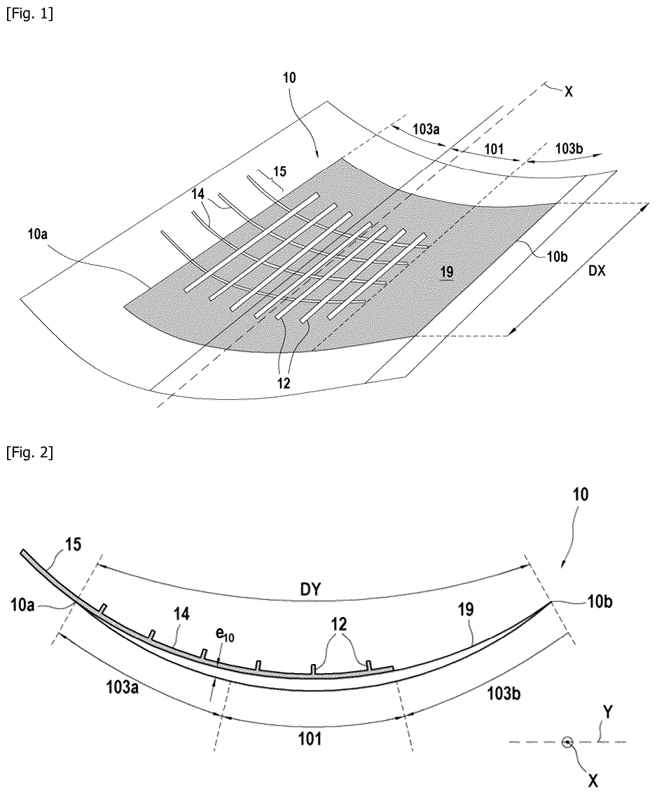

The panels 10 extend along an X axis, corresponding to the axis of the cylinder obtained after juxtaposition of the panels, and have a curved shape in cross section with respect to the X axis. The panels 10 may or may not have an elongated shape along the X axis, depending on the geometry desired for the part. The panels 10 define two edges 10a, 10b which are, in the example illustrated, intended to be superposed with an adjacent panel, as will be described hereinafter, The edges 10a, 10b extend along the X axis, and may be colinear with this axis as illustrated. FIG. 1 Illustrates an example of a possible structure for the panels 10 which are draped in a female tool; the person skilled in the art will recognize that the panels can alternatively be draped on a male tool without exceeding the scope of the present invention. The draping form is not an integral part of the vacuum molding tool so it allows simultaneous draping and heating operations, thus reducing the manufacturing cycle time, The panels 10 are, in the example of FIG. 1, provided with rectilinear stiffeners 12 made of thermoplastic composite. Each stiffener 12 is formed by a fibrous reinforcement impregnated with a thermoplastic resin which is identical to, or failing that, compatible with the resin or resins of the panels 10. These stiffeners 12 are formed by conventional means known to the person skilled in the art, for example by manual or automated draping, draping in a shaped mold or stamping in a press of flat green plates, creating dry preforms and injecting resin into a mold by a resin transfer molding (RTM) technique. The stiffeners 12 may have any cross-section, for example omega-, T- or J-shaped, among other possible shapes. The stiffeners 12 may or may not have a local variation in shape or section. As illustrated, the stiffeners 12 may be present over at least the majority (more than 50%), or even at least 80%, of the dimension DX of the panels measured along the X axis.

The panels 10 shown are also provided with circumferential frame sectors 14 made of thermoplastic composite that constitute stiffening elements. Each frame sector 14 is formed by a fibrous reinforcement impregnated with a thermoplastic resin which is identical to, or failing that, compatible with the resin or resins of the panels 10 and the stiffeners 12. As for the stiffeners 12, the frame sectors 14 are formed in a manner known per se. The frame sectors 14 may have any cross-section, for example Z-, C-, F-, T-, omega- or J-shaped. Each frame sector may have a joggle at the ends (so as to overlap with the other frame sectors to form the complete frame) or may be straight (to join the other frame sectors via a splice bar). The frame sectors 14 may have variations in shape at the base plates that will be in contact with the panel 10 (to best adjust to the variations on the panel 10 side). The frame sectors 14 may have notches traversed by the stiffeners 12 and cooperating with these stiffeners, These notches may have the same shape and substantially the same dimensions as the stiffeners 12 passing through them. The frame sectors 14 can be assembled to the stiffeners 12 by an interface piece, but it would not be exceeding the scope of the invention if such a piece is omitted.

The frame sectors 14 and the stiffeners 12 are assembled on an internal surface of the cylinder once the panels 10 have been juxtaposed. In general, it will be noted that the panels 10 may include zones of increased thickness forming local reinforcements.

The stiffeners 12 and frame sectors 14 are assembled on the panels 10 by techniques known per se, such as spot welding, stapling, or the use of attached fasteners. The purpose of this assembly is simply to position the stiffeners 12 and frame sectors 14 on the panels 10, but not to produce a robust securement of the latter to the panels 10; this is obtained after the co-consolidation which will be described below.

In the example illustrated, the panels 10 also have a zone 19, situated on the side of the edge 10b and extending over the entire dimension DX, which is devoid of stiffening elements (no stiffener 12 or frame sector 14). It will also be noted that, in the example illustrated, the frame sectors 14 project from the panel 10 on the side opposite the zone 19 (on the side of the edge 10a) and form an extension 15 of the frame sectors 14. The presence of the zone 19 as well as the extension of the frame sectors 14 are the result of the arrangement envisaged for the juxtaposition between adjacent panels 10.

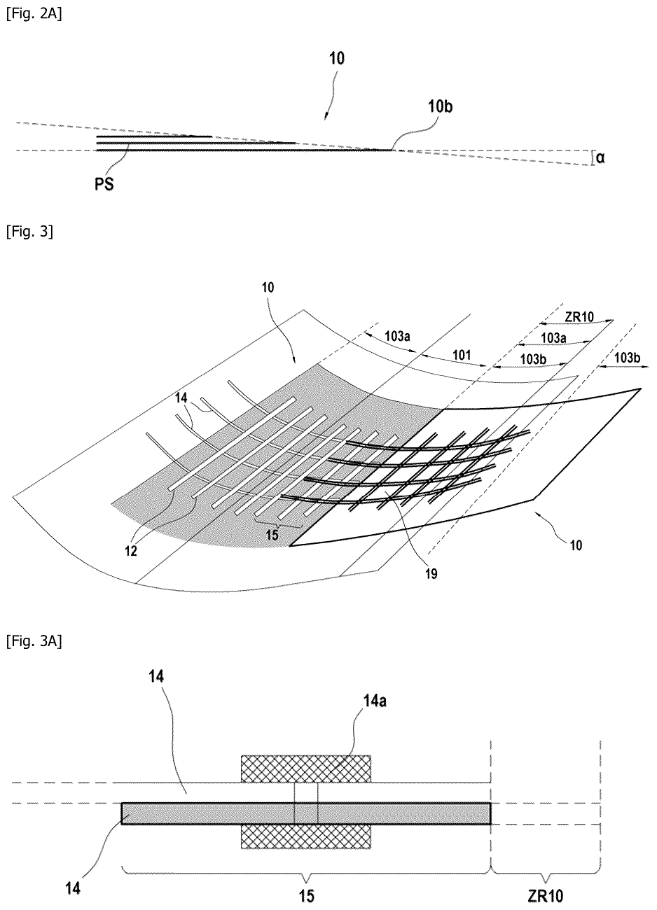

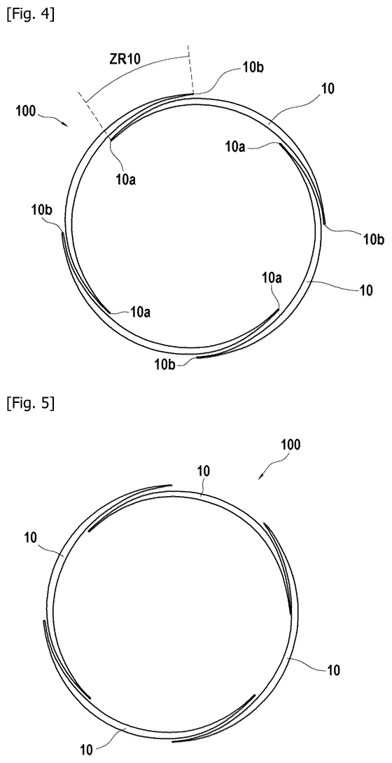

FIG. 2 shows the evolution of the thickness e10 of the panels 10 along the Y axis perpendicular to the X axis. The panels 10 have a middle zone 101 of their width where the thickness e10 is substantially constant, and two lateral zones 103a and 103b each situated on the side of a respective edge 10a, 10b which have a varying thickness. The zone 101 is situated between the zones 103a, 103b. The zone 103a connects the zone 101 to the edge 10a, and the zone 103b connects the zone 101 to the edge 10b. More precisely, the zones 103a, 103b become thinner in the direction of the associated edge 10a, 10b. The thickness e10 may decrease strictly in the direction of the edge 10a, 10b. The thickness e10 is minimum on the edges 10a, 10b and maximum on the middle zone 101. The panels 10 have a bevel on their edges 10a, 10b. in cross-section, the panels 10 have a shape that tapers toward their edges 10a, 10b with respect to the X axis. The zones 103a and 103b together occupy at least 5%, for example at least 50%, of the dimension DY of the panel 10. Unless otherwise stated, the dimension DY corresponds to the length of the arc of a curve connecting the edge 10a to the edge 10b. The reduction of the thickness leads to a thickness e10 decrease of at least 50%, for example of at least 90%. This thickness e10 decrease is, for example, comprised between 50% and 95%, or even between 90% and 95%. FIG. 2A schematically shows a reduction in the thickness of the panel 10 in the direction of an edge 10b associated with the presence of a decreasing quantity of superimposed folds PS in the direction of the edge 10b. The angle α of the bevel, corresponding to the angle taken locally on the edge 10b, can advantageously be less than or equal to 1.5°, so as to further improve the smoothing of the forces, The juxtaposition of these panels 10 to form the sectorized cylinder 100 is described below in relation to FIGS. 3 to 7. The stiffeners 12 and frame sectors 14 have not been shown in FIGS. 4 to 7.

FIG. 3 illustrates the juxtaposition of two adjacent panels 10 around the X axis. The two panels 10 illustrated have the same structure and the same references are retained with respect to what has just been described. The panels 10 partially overlap here. The panels have a reduced thickness in their overlap zone ZR10, that is to say that the zone 103b of the first panel 10 is covered by the zone 103a of the adjacent second panel 10. The edge 10b of the first panel 10 is superposed with the adjacent second panel 10, and the edge 10a of the second panel 10 is superposed with the first panel. The stiffeners 12 and frame sectors 14 of the second panel 10 cover the zone 19 of the first panel 10. The extension 15 of the frame sectors 14 of the second panel 10 extends over the zone 101 of the first panel and is positioned adjacent to and in the extension of the frame sectors 14 of the first panel. The extension 15 extends beyond the overlap zone ZR10, which here corresponds to the junction zone between the panels 10. The extension 15 is assembled with the frame sectors 14 of the first panel 10 by techniques known per se, for example by overlapping, joggling or splicing. This assembly can be carried out outside the zone ZR10. FIG. 3A illustrates an example of such an assembly in which a splice bar 14a, present outside the zone ZR10, connects the frame sectors 14 of the first and second panels 10. The splice bar 14a may also comprise a thermoplastic material so as to ensure its welding to the frame sectors 14 during co-consolidation.

The arrangement which has just been described can be applied to each pair of adjacent panels 10 juxtaposed to form the sectorized cylinder. In general, the overlap zones between adjacent panels can occupy at least 5%, for example at least 30% of the perimeter of the sectorized cylinder. The fact of having spread-out overlapping zones makes it possible to further improve the mechanical properties of the part obtained. In particular, when all the panels are assembled to form the sectorized cylinder, the joining of the frame sectors 14 of each of the panels defines a plurality of 360° circumferential frames.

FIGS. 4 to 7 show different variants of juxtaposition of the panels 10 to form the sectorized cylinder 100. The cylinder 100 is an X-axis cylinder with panels juxtaposed around this axis. The X axis corresponds to the axis of revolution of the cylinder.

In the variant of FIG. 4, the cylinder 100 is formed by overlapping all the panels 10 in a tiled manner, i.e. each of the panels has a first edge 10b overlapping (above) a first adjacent panel, and a second edge 10a opposite the first edge 10b overlapped (below) by a second adjacent panel opposite the first adjacent panel. Note in particular the reduced thickness of the adjacent panels 10 over their overlap zone ZR10 in the direction of their edges 10a, 10b.

In the variant of FIG. 5, the panels overlap in a tiled manner except for the panel 10 at the bottom right of the figure which overlaps its two adjacent panels.

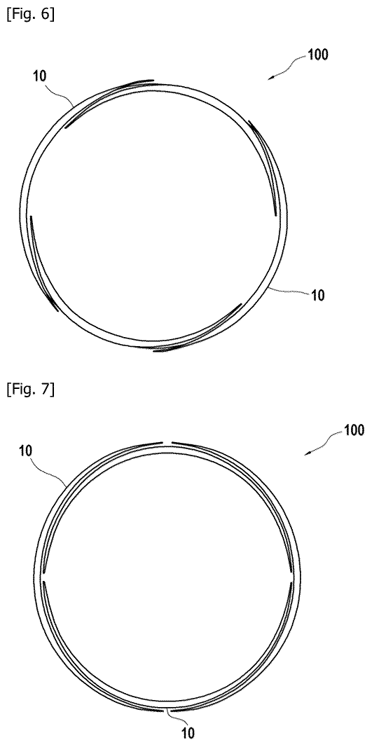

The variants of FIGS. 6 and 7 show cases where there is no overlap which are also covered by the present invention.

The case of beveled panels 10, having a reduced thickness on their overlap zone, has just been described. It will be noted that does not exceed the scope of the invention when the panels have straight sides or have a joggle (which will make it possible to assemble them by overlapping).

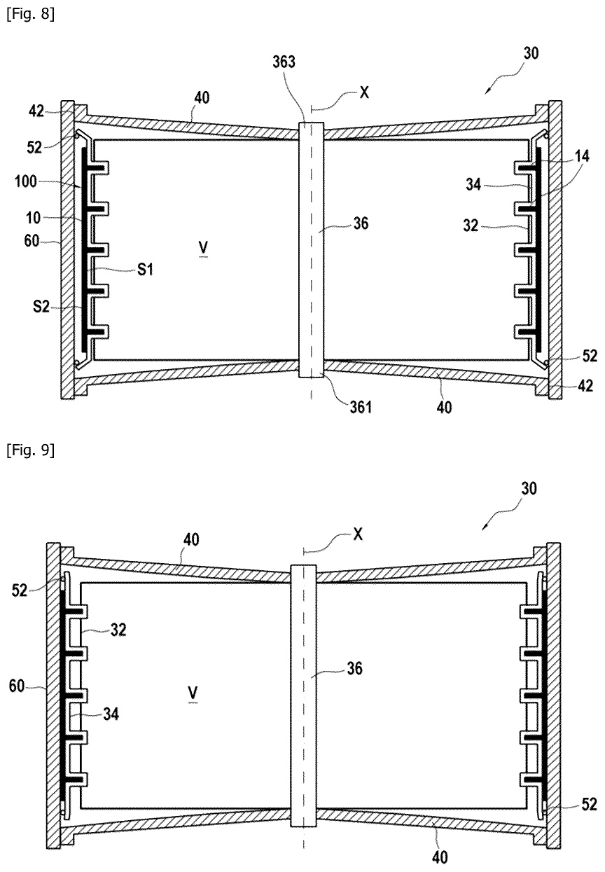

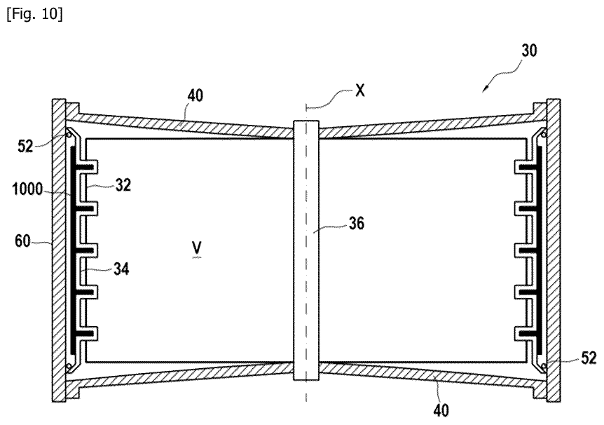

The following describes the positioning in the vacuum molding tool. The possible kinematics for the assembly of the vacuum molding tool 30 and positioning of the precursor assembly will now be detailed in relation to FIG. 8. In this figure, as well as in FIGS. 9 and 10, the relative thicknesses as well as the spacings between the different elements have not been strictly respected for reasons of readability.

A vacuum bag 34 is initially placed on a positioning part 32. Part 32 is much simpler in design than a molding surface insofar as it is simply used for positioning the elements. It is therefore more easily dismantled. The part 32 is supported by a shaft 36 which extends along the X axis which corresponds to the X axis of the panels 10 and of the cylinder 100, which has been described previously. The part 32 may have an aerated structure, for example a lattice structure, or may have a plurality of retractable positioning elements fixed to the shaft. The part 32 may, as illustrated, generally have the shape of the part to be obtained. The bag 34 covers the part 32. The bag 34 may be composed of elastomer material, optionally reinforced, and constitutes an element known per se.

Positioning rings 40 are then positioned at the ends 361, 363 of the shaft 36, which define a cylindrical positioning surface 42 intended to guide the external molding part 60 during its positioning.

The panels 10 are then positioned and juxtaposed, in the manner described above, so as to form the precursor cylinder 100 of the part to be obtained. The cylinder 100 is positioned around the part 32 (and the bag 34). In the example illustrated, each panel 10 bears a plurality of frame sectors 14 and a plurality of stiffeners 12. The part 32 may define housings, for example in the form of cavities opening onto the surface of the part 32, in which the stiffening elements 12, 14 are positioned. The stiffening elements 12, 14 may bear on a wall defining the cavities, or on a positioning element present in the cavities, in order to assist their placement in the tool 30.

The cylinder 100 delimits an internal volume V of the part to be obtained. The cylinder 100 is made of thermoplastic preimpregnated fibrous material. The stiffening elements 12, 14 are assembled on an internal surface S1 of the cylinder 100. In the example illustrated, the stiffeners 12 borne by the cylinder 100 may be regularly spaced along a circumferential direction, around the X axis. Similarly, the frame sectors 14 borne by the cylinder 100 may be regularly spaced along the X axis. However, it does not exceed the scope of the invention when these spacings are not regular, the positioning of the stiffening elements being adjusted according to the part and the stresses to which it is subjected during operation.

In the example illustrated, the cylinder 100 has a diameter greater than its dimension along the X axis. However, It does not exceed the scope of the invention when the invention is applied to the formation of parts having an elongated shape along the X axis, for example having a length of at least ten meters.

The external molding part 60 is then positioned, which is in the shape of the part to be obtained and which surrounds the cylinder 100. The cylinder 100 is situated inside the part 60. The part 60 is situated around the cylinder 100. As illustrated, the part 60 extends from one ring 40 to the other. It faces the surface 42. An internal surface S1 of the cylinder 100 is situated on the side of the bag 34 (and delimits the internal volume V), and an external surface S2 of the cylinder 100 is situated on the side of the part 60. In the example illustrated, the shaft 36, as well as the tool 30, are oriented vertically, but the person skilled In the art will recognize that the invention can be applied to a tool 30 extending horizontally. In this case, it may be useful to provide the molding part with stiffeners on its face opposite the assembly so that it retains its shape, especially if the manufacture of a part of substantial length is envisaged.

The seals 52 between the bag 34 and the part 60 are then produced.

The precursor assembly is thus positioned in the vacuum molding tool 30 in order to form the part by co-consolidation. In particular, the cylinder 100 is interposed between the bag 34 and the molding part 60. The part 32 is situated inside the precursor assembly, that is to say it is situated inside the internal volume V of the part to be obtained. The part 60 is situated outside this internal volume V and forms a part external to the assembly, intended for molding the part.

In the example illustrated, the panels 10 are juxtaposed around the X axis with overlap between the adjacent panels. The adjacent panels 10 may be in contact on their overlap zone ZR10. The stiffeners 12 and frame sectors 14 may be in contact with the panels 10, and therefore with the internal surface of the cylinder 100.

A vacuum is created in tool 30 so that the bag 34 presses the stiffening elements 12, 14 on the internal surface S1 of the cylinder 100 and conforms the assembly to the desired shape against the part 60. In particular, the vacuum draw leads to the panels 10 bearing against their overlapping zone ZR10, as well as to the application of pressure to the stiffeners 12 and frame sectors 14 that are pressed against the internal surface S1. Pressure is also applied to any third assembly elements, useful for connecting the frame sectors 14 of adjacent panels 10, in order to press the assembly to be connected against the surface S1.

Heating is then carried out, maintaining the vacuum draw, which leads to melting or softening of the thermoplastic resin or resins present. The fluidization of the resin or resins promotes the conformation of the elements to be welded and produces interpenetration of the polymer chains at the interfaces between these elements. Accordingly, during heating:
for each pair of adjacent panels, the resin of a first panel penetrates into a second adjacent panel and the resin of the second panel penetrates into the first panel,
the resin or resins of the stiffening elements penetrate into the panel on which these elements are assembled and the resin of the panel in question penetrates into these stiffening elements, and
the resin of a first set of frame sectors 14 penetrates into a second set of frame sectors 14 adjacent to this first set.

Heating can be carried out in a heating chamber, such as an oven or an autoclave. The autoclave will provide additional pressure beyond the vacuum draw. As a variant or in combination, it is possible to use a molding tool equipped with heating elements (not shown) to perform this heating. The temperature imposed during the heating depends on the resin(s) used and may, for example, be greater than or equal to 300° C., for example, be comprised between 300° C. and 400° C.

After heating, cooling is performed to set the structure (in particular to solidify the thermoplastic resin(s) present) and to obtain the part 1000 (FIG. 10). In general, the vacuum draw can be maintained during this cooling. Cooling makes it possible to obtain a welded junction between the different elements of the part because of the interpenetration of the polymer chains of the resin(s) present previously carried out during heating. The part 1000 is tubular of cylindrical shape and forms a stiffened shell. It constitutes an integrated structure with assembly by co-consolidation of all the constituent elements of the structure. In particular, the panels 10 are welded together by co-consolidation to form the shell, the stiffeners 12 and frame sectors 14 are welded by co-consolidation on the internal surface of the part 1000, and the frame sectors 14 are welded together by co-consolidation (by overlapping or splicing, for example).

A tool 30 made of composite material may be used to reduce the phenomenon of differential expansion between the tool 30 and the part 1000. As a variant, the tool 30 may be metal, for example Invar or steel. In the latter case, it may be advantageous to minimize the stresses during cooling by providing a partial opening of the part 60.

The tool 30 is then dismantled, which is facilitated by the positioning of the molding part 60 outside the resulting part 1000, and by the simplified design of the internal part 32.

The part 1000 obtained may be integrated into a space launcher, for example as an interstage or intertank shell, or else form a tank after having bottom elements attached. However, the field of the invention is not limited to a part for integration into an aerospace launcher and the part may, as a variant, find an application in the aeronautical field or, more generally, in any application requiring a stiffened shell.

The expression “comprised between . . . and . . .” should be understood to include the bounds.

1. A method for manufacturing a part of cylindrical shape made from stiffened thermoplastic composite material, the method comprising:
positioning a precursor assembly of the part to be manufactured in a vacuum molding tool, the assembly being made of thermoplastic preimpregnated fibrous material and comprising (i) a sectorized cylinder formed by panels juxtaposed around an axis of the cylinder, and (ii) stiffening elements assembled on each of the panels and present on an internal surface of the cylinder,
the tool comprising an internal part lined with a vacuum bag, facing the internal surface of the cylinder and stiffening elements, on which the assembly is positioned, and an external molding part of cylindrical shape, facing an external surface of the cylinder, and
the conformation of the assembly on the external molding part and the formation of the part by co-consolidation of the stiffening elements and the cylinder, comprising:
heating the assembly during which a vacuum is drawn in the molding tool so that the vacuum bag applies pressure to press the stiffening elements against the internal surface of the cylinder and shape the assembly against the external molding part, and during which the thermoplastic resin(s) present in the assembly are melted or softened, and
cooling the assembly, after said heating, during which the temperature is reduced to set the shape of the assembly thus produced and obtain the composite material part to which the stiffening elements are secured.

2. The method according to claim 1, wherein the sectorized cylinder is formed by the panels juxtaposed around the cylinder axis with overlap between adjacent panels.

3. The method according to claim 2, wherein the adjacent panels have a thinner part on their overlapping zone in the direction of their edges.

4. The method according to claim 1, each panel comprises a plurality of circumferential frame sectors extending beyond said panel to form an extension, said extension being joined to the frame sectors of an adjacent panel outside a junction zone between these two panels.

5. The method according to claim 1, method further comprising, prior to positioning the precursor assembly in the molding tool, forming the panels by automatic fiber placement, the panels being draped on a shape distinct from the positioning internal part.

6. The method according to claim 1, the panels and stiffening elements comprise carbon fibers, glass fibers, aramid fibers, or a mixture of such fibers.
